(19) United States
(12) Patent Application Publication
(10) Pub. No.: US 2013/0057382 A1
(43) Pub. Date: Mar. 7, 2013

(54) THERMAL FUSE

(71) Applicant: CHUN-CHANG YEN, Hsinchu City (TW)

(72) Inventor: CHUN-CHANG YEN, Hsinchu City (TW)

(21) Appl. No.: 13/666,989

(22) Filed: Nov. 2, 2012

Related U.S. Application Data
(63) Continuation-in-part of application No. 12/781,828, filed on May 18, 2010.

(51) Int. Cl. H01H 37/76

(52) U.S. Cl. 337/414

(57) ABSTRACT

A thermal fuse which has its conducting element made of red brass. As such, the conducting element has an identical thermal coefficient as that of a red-brass casing, and the robustness against heat of the conducting element's petals is compatible with that of the casing. In this way, the conducting element will not be stuck with the casing when an overloading current emerges. The thermal fuse therefore is significantly more reliable than a conventional thermal fuse.

### CROSS-REFERENCE TO RELATED APPLICATION

This is a continuation-in-part of the co-pending patent application Ser. No. 12/781,828, filed May 18, 2010.

### TECHNICAL FIELD OF THE INVENTION

The present invention generally relates to thermal fuses, and more particular to a thermal fuse whose conducting element is made of red brass and coated with a thin layer of silver.

### DESCRIPTION OF THE PRIOR ART

A conventional thermal fuse, as shown in FIGS. 1 and 2, contains a tubular casing 10 within which a thermal sensing element 50 (usually in the form of compressed powders), a copper plate 16, a conical spring 15, another copper plate 14, and a conducting element 40 are sequentially placed through a first end of the casing 10. The conducting element 40 has a number of petals 42 that join at one end and curve towards a same direction so as to form a bowl shape. When the conducting element 40 is placed inside the casing 10, the petals 42 are therefore able to touches an inner wall of the casing 10. Then a first conducting rod 20 is threaded through a ceramic and insulating inner bush 11 and locked with the inner bush 11 by a flange 21 near a first end of the first conducting rod 20. A small section of the first conducting rod 20 behind the first end is exposed out of the inner bush 11. A helix spring 13 is then placed around the exposed section of the first conducting rod 20 and in front of the inner bush 11. The helix spring 13, the inner bush 11, and the first conducting rod 20 are together inserted through the first end of the casing 10 until the first end of the first conducting rod 20 and the helix spring 13 touch a bottom 41 of the bowl-shaped conducting element 40. A second end of the first conducting rod 20 is then threaded through an outer bush 12 and an insulating adhesive 60 is applied to seal the first end of the casing 10 and to join the inner bush 11 and the outer bush 12 integrally together. Finally, a second conducting rod 30 is joined to a second end of the casing 10 by a riveting material 70.

The operation of the thermal fuse is as follows. Normally, electrical current runs through the second conducting rod 30, the casing 10, the conducting element 40, and the first conducting rod 20. When the temperature rises above a threshold, the thermal sensing element 50 is liquidized and the conical spring 15 expands and pushes the copper plate 16 towards the thermal sensing element 50. Some liquidized thermal sensing element 50 would flow behind the copper plate 16 and the balance between the conical spring 15 and the helix spring 13 cannot be maintained. The helix spring 13 therefore also pushes the conducting element 40 towards the thermal sensing element 50. The conducting element 40 is as such moved away from the first conducting rod 20 which is locked by the inner bush 11 and cannot move along with the conducting element 40. The contact between the conducting element 40 and the first conducting rod 20 is therefore disrupted and electrical current cannot flow from the second conducting rod 30 to the first conducting rod 20. The thermal fuse can provide a one-time protection as described above. Afterwards, the thermal fuse can on longer be used.

It is not uncommon that the conventional thermal fuse fails to provide the protection function. When there is an overload current and the temperature rises, the conducting element 40 is softened by the heat and stuck with the casing 10. Even though the thermal sensing element 50 is liquidized, the conducting element 40 is not pushed away to break electrical contact with the first conducting rod 20.

### SUMMARY OF THE INVENTION

Therefore, a thermal fuse is provided herein to obviate the problem of stuck conducting element of a conventional thermal fuse. The thermal fuse according to the present invention has an identical structure with a conventional one. The gist of the present invention lies in the material making up the conducting element. According to the present invention, the conducting element is made of red brass and has an identical thermal coefficient as that of the red-brass casing, and the robustness against heat of the petals of the conducting element is compatible with that of the casing. In this way, the conducting element will not be stuck with the casing when an overloading current emerges. The thermal fuse according to the present invention therefore is significantly more reliable than a conventional thermal fuse.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a perspective break-down diagram showing the various components of a conventional thermal fuse and of a thermal fuse of the present invention.

FIG. 2 is a sectional diagram showing the thermal fuse of FIG. 1.

FIG. 3 is a top-view diagram showing a conducting element of the thermal fuse of FIG. 1.

FIG. 4 is a side-view diagram showing a conducting element of the thermal fuse of FIG. 1.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

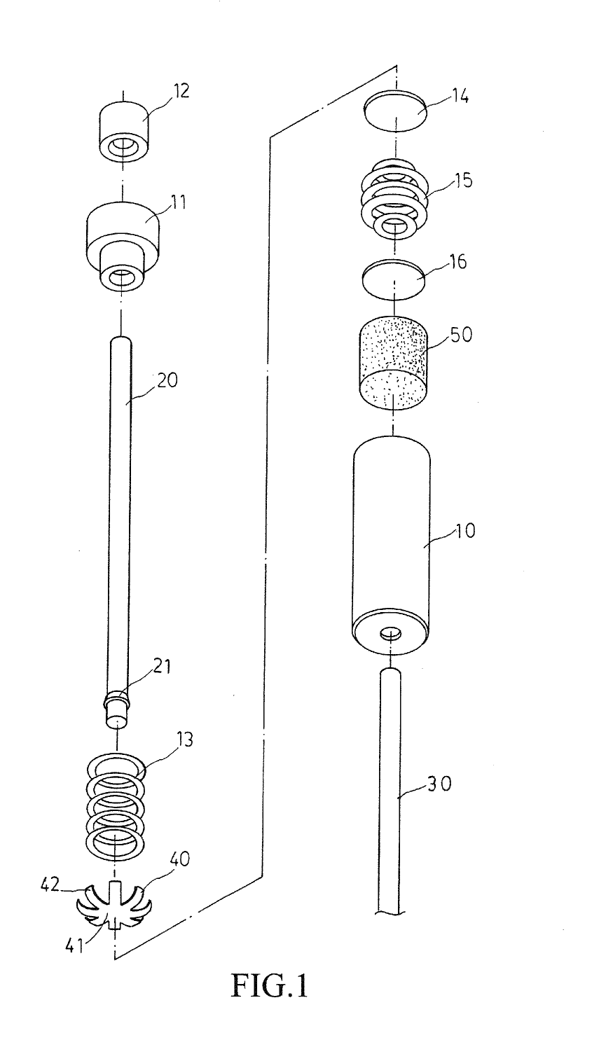

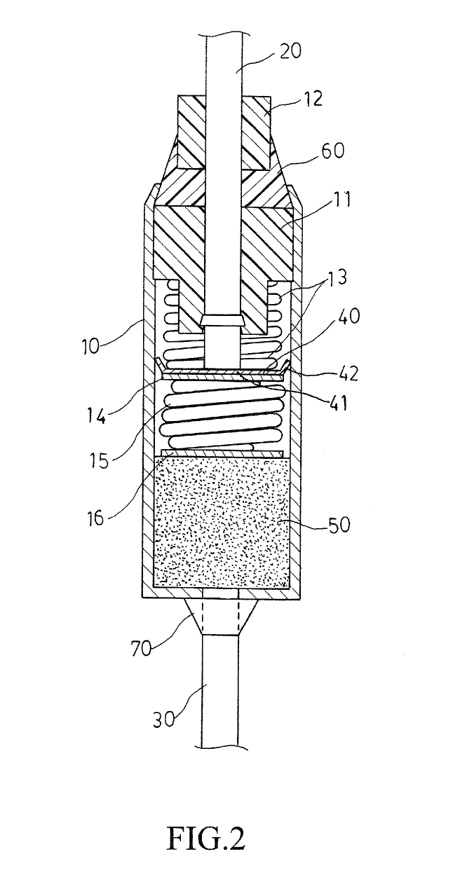

The thermal fuse according to the present invention has an identical structure with a conventional one as depicted in FIGS. 1 and 2. The thermal fuse contains a tubular casing 10 made of red brass within which a thermal sensing element 50 (usually in the form of compressed powders), a copper plate 16, a conical spring 15, another copper plate 14, and a conducting element 40 are sequentially placed through a first end of the casing 10. Then a first conducting rod 20 made of red brass is threaded through a ceramic and insulating inner bush 11 and locked with the inner bush 11 by a flange 21 near a first end of the first conducting rod 20. A small section of the first conducting rod 20 behind the first end is exposed out of the inner bush 11. A helix spring 13 is then placed around the exposed section of the first conducting rod 20 and in front of the inner bush 11. The helix spring 13, the inner bush 11, and the first conducting rod 20 are together inserted through the first end of the casing 10 until the first end of the first conducting rod 20 and the helix spring 13 touch a bottom 41 of the bowl-shaped conducting element 40. A second end of the first conducting rod 20 is then threaded through an outer bush 12 and an insulating adhesive 60 is applied to seal the first end of the casing 10 and to join the inner bush 11 and the outer bush 12 integrally together. Finally, a second conducting rod 30 is joined to a second end of the casing 10 by a riveting material 70.

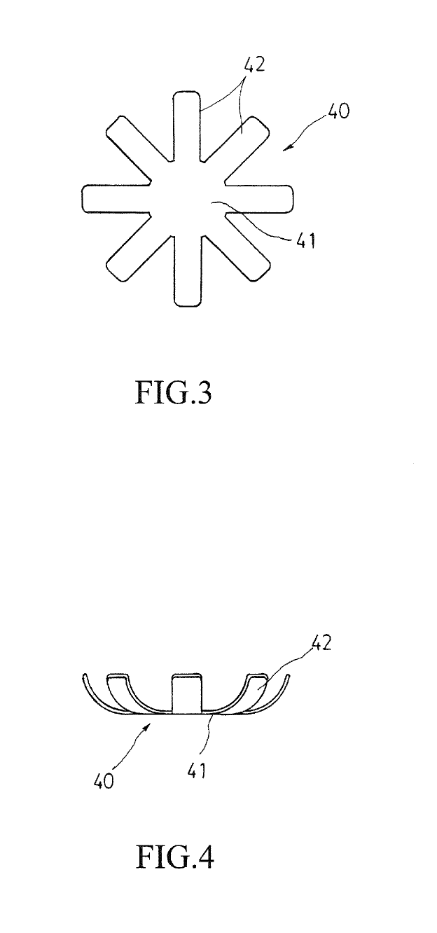

The conducting element 40, as shown in FIGS. 3 and 4, has a number of petals 42 that join at one end and curve towards a same direction so as to form a bowl shape. When the conducting element 40 is placed inside the casing 10, the petals 42 are therefore able to touches an inner wall of the casing 10. The gist of the present invention lies in the material making up the conducting element 40. According to the present invention, the conducting element 40 is made of red brass and has an identical thermal coefficient as that of the red-brass casing 10, and the robustness against heat of the petals 42 of the conducting element 40 is compatible with that of the casing 10. In this way, the conducting element 40 will not be stuck with the casing 10 when an overloading current emerges. The thermal fuse according to the present invention therefore is significantly more reliable than a conventional thermal fuse.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A thermal fuse, comprising:
a tubular casing made of red brass and having a predetermined thermal coefficient;
a thermal sensing element capable of being liquidized under a high temperature, said thermal sensing element placed inside said casing adjacent to a second end of said casing;
a first copper plate, a conical spring, a second copper plate, and a conducting element sequentially placed inside said casing behind said thermal sensing element where said conducting element is made of red brass and has a thermal coefficient identical to the predetermined thermal coefficient;
a ceramic and insulating inner bush;
a first conducting rod made of red brass threaded through said inner bush and locked with said inner bush by a flange near a first end of said first conducting rod where a small section of said first conducting rod behind said first end is exposed out of said inner bush;
a helix spring placed around said exposed section of said first conducting rod and in front of said inner bush, where said helix spring, said inner bush, and said first conducting rod are together inserted through said first end of said casing until said first end of said first conducting rod and said helix spring touch a bottom of said bowl-shaped conducting element;
an outer bush through which a second end of said first conducting rod is threaded;
an insulating adhesive applied to seal said first end of said casing and to join said inner bush and said outer bush integrally together; and
a second conducting rod joined to said second end of said casing by a riveting material.
